(19) United States
(12) Patent Application Publication
(10) Pub. No.: US 2007/0222859 A1
(43) Pub. Date: Sep. 27, 2007

(54) Method for digital video/audio recording with backlight compensation using a touch screen control panel

(75) Inventors: Hung C. Chang, Sugar Land, TX (US); Allan Chen, Sugar Land, TX (US); William Chichih Tai, Sugar Land, TX (US)

Correspondence Address: PATTERSON & SHERIDAN, L.L.P., 3040 POST OAK BOULEVARD, SUITE 1500, HOUSTON, TX, 77056, US

(73) Assignee: Coban Research and Technologies, Inc.

(21) Appl. No.: 11/387,431

(22) Filed: Mar. 23, 2006

(51) Int. Cl. H04N 7/18

(52) U.S. Cl. 348/148

(57) ABSTRACT

Aspects of the present invention include method and apparatuses that may utilize a digital video recording device with a screen control panel, for example, a touch screen control panel, to record digital video data with adjusted light compensation based on a selected object within a scene. For example, a user, using a touch screen control panel, may choose an object within a scene. Based on this selection, the digital video recording device may adjust the backlight compensation settings and camera angle to obtain a better image of the selected object. A user may select an object by touching the image of the object, tracing the selected object, or touching a number of reference points of the object. Then, depending on the user selection, the digital video recording device may take a snapshot, zoom in and take a snapshot, record the scene, or it may lock on the object and readjust and track the object as the object moves, while recording the scene.

### BACKGROUND OF THE INVENTION

1. Field of the Invention

The present invention relates generally to digital video recording devices, and more particularly, to methods and apparatuses for digital video recording with backlight compensation using a touch screen control panel. Description of the Related Art

Digital technology has allowed law enforcement agencies around the world to make audio and video recording an essential tool for protection against false and malicious claims, for prosecuting defendants, and for training. Digital video recording provides obvious benefits over analog (VCR tape-based) video recording systems in quality, storage and a variety of options, such as the ability to search and locate a particular scene within a recording segment.

As shown in FIG. 1, generally, a digital video recording device 106, in a law enforcement vehicle 110, is in communication with a video camera 120, a general purpose computer 107, which may be separate as shown or integrated with the digital video recording device 106 as one unit, an audio input device (not shown), and a storage medium, for example, a hard disk drive 105. Digital video recording device 106 may interface with triggering devices (e.g., siren, light bar, air bag, vibration sensor) and/or switches for triggering permanent recording of the video and audio data to the hard disk drive 105. The video camera 120 is generally mounted to capture video data out the front window of the vehicle 110. An audio input device (not shown) may, in any combination, be mounted in the vehicle 110, worn by an officer, and/or provided as an output of the vehicle's two-way radio. Naturally, it is imperative that the images captured by the digital video recording device are clear and recognizable in order for them to be used effectively by law enforcement agencies when reviewing the material for investigations and other related purposes at a later time.

One disadvantage of the digital video recording device described above is that it lacks the ability to capture bright and dark areas within the same scene with equal clarity. When photographing and recording an object with the digital video recording device in various lighting conditions, such as bright sun, incandescent light, or at night, the object is placed in an illuminated backlight state and thus, a shaded or a blurred image may be obtained. Although the digital video recording device may use backlight compensation to obtain increased clarity for the overall scene by reducing the influence of illumination, as a result certain parts of the scene may appear darker, overexposed or unrecognizable.

In conventional backlight compensation systems, such as the one used in the digital video recording device described above, a user is required to manually select an ambient illumination level by choosing from a number of keys corresponding to a fixed backlight compensation level for a particular scene and lighting condition. This requires significant user attention to monitor and readjust the camera lights continuously. Even if the digital video recording device were to be initially adjusted according to a set of pre-determined parameters selected by the user, the required adjustments would be likely to change in response to changing camera orientations, changing lighting conditions, or other events within a monitored area. As a result, the user of the digital video recording device would be distracted from the task of providing vigilant attention to activities within his surroundings.

Therefore, a need exists for an improved method and an apparatus for digital video recording.

### SUMMARY OF THE INVENTION

One embodiment of the present invention provides a vehicle-mounted digital video recording device for capturing video data during an event comprising a storage medium, a touch screen control panel, and a processing device configured to record a scene, receive a user selection of an object within the scene and then automatically perform compensation in order to enhance recognition of the selected object within the scene.

Another embodiment of the present invention provides a method for recording video data with a vehicle-mounted digital video capturing device corresponding to an event comprising displaying a scene representing the video data on a touch screen control panel while recording the scene, and performing compensation in response to a user selection of a particular object or area located within the scene in order to enhance recognition of the selected object in the scene.

Another embodiment of the present invention provides a method for recording video data corresponding to an event, comprising displaying a scene representing the video data on a touch screen control panel, locking on the object in response to a user selection, wherein the digital video recording device is adapted to follow and track the object while recording its movements, and performing compensation in response to the user selection of the object in order to enhance recognition of the selected object in the scene, wherein the selected object may appear more enhanced than other parts of the scene.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary layout of a law enforcement vehicle, using a digital video recording device;

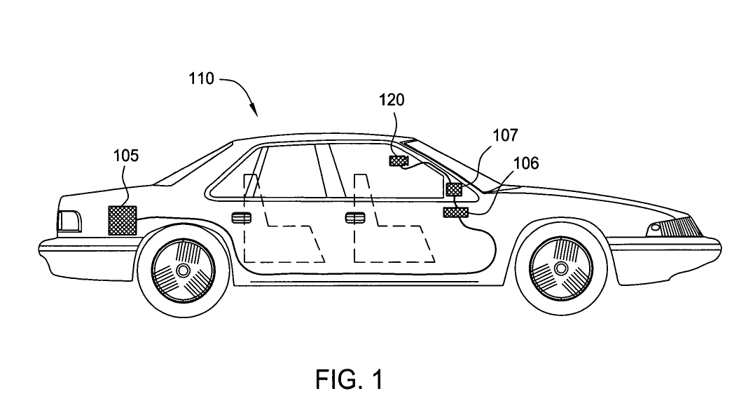

FIG. 2A illustrates a scene captured on a screen control panel according to an embodiment of the present invention;

FIG. 2B illustrates the captured scene of FIG. 2A with lighting compensation adjusted for a selected object according to an embodiment of the present invention;

FIG. 3A and 3B illustrate a selected object from a scene captured on a screen control panel according to an embodiment of the present invention; and

FIG. 4 illustrates a flow diagram of a method according to an embodiment of the present invention.

### DETAILED DESCRIPTION

Embodiments of the present invention provide methods and apparatuses that may utilize a digital video recording device with a screen control panel, for example, a touch screen control panel, to record digital video data with adjusted light compensation based on a selected object within a scene. For example, a user, using a touch screen control panel, may choose an object within a scene. Based on this selection, the digital video recording device may adjust the backlight compensation settings and camera angle to obtain a better image of the selected object. A user may select an object by touching the image of the object, tracing the selected object, or touching a number of reference points of the object. Then, depending on the user selection, the digital video recording device may take a snapshot, zoom in and take a snapshot, record the scene, or it may lock on the object and readjust and track the object as the object moves, while recording the scene. In this way, the digital video recording device ensures that clear images (e.g., enhanced images) can be captured.

While the following description of the system is described with reference to a law enforcement vehicle, the same techniques may be applied to other applications where surveillance and video data monitoring may be useful, such as military and security systems.

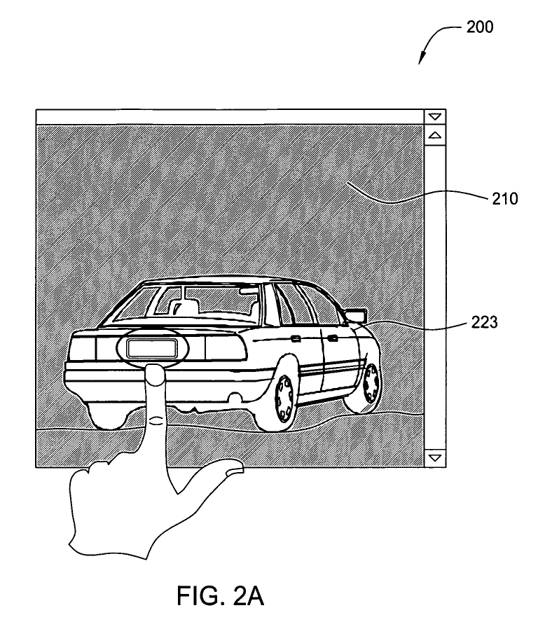

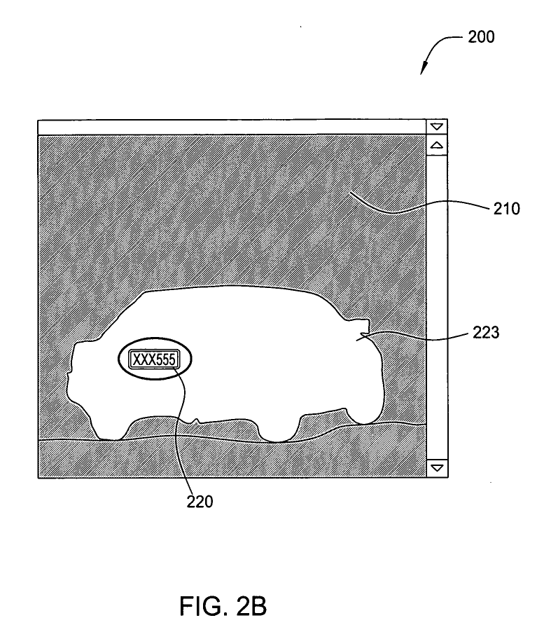

FIG. 2A illustrates a scene 210 captured on a screen control panel 200 of a digital video recording device according to an embodiment of the present invention. The screen control panel of the digital video recording device may be a touch screen control panel (e.g., sensitive to the touch of a finger and/or stylus).

The digital video recording device may start capturing video data and display that video data on touch screen control panel 200, as soon as it is turned on or once it detects a start triggering event. Depending on the lighting conditions, in an attempt to provide a clear overall image of the entire scene, the digital video recording device may compensate for an overall lack of scene clarity by providing automatic backlight compensation. However, certain parts of the scene, for example, license plate 220, may appear darker, overexposed, or unrecognizable. As will be described later, embodiments of the present invention may be able to overcome this problem by utilizing an advanced backlight compensation method via a touch screen control panel.

While backlight compensation is described, other types of compensation may be performed automatically on a selected object or an area within a scene as well. For example, in one embodiment of the present invention, in an effort to enhance an image that would have otherwise been unreadable or unrecognizable, the brightness, sharpness and/or contrast may be adjusted in order to achieve an enhanced image.

In one embodiment of the present invention, a user, for example, an officer, may select an object or an area containing an object of interest located in the scene, for example license plate 220, by touching the license plate displayed on the touch screen control panel 200, as shown in FIG. 2A.

In response, the digital video recording device may center the selected object on the touch screen control panel, tilt the camera, and change the backlight compensation settings based on the lighting conditions of the surrounding area.

As shown in FIG. 2B, after the adjustments are made for preferred lighting on the selected object, the object of interest may appear more clearly and recognizable for recording. On the other hand, portions of the screen that may not hold great significance and are not selected may appear to be darker in comparison to the selected object. For example, the body of the automobile 223 may appear to be darker in comparison to license plate 220.

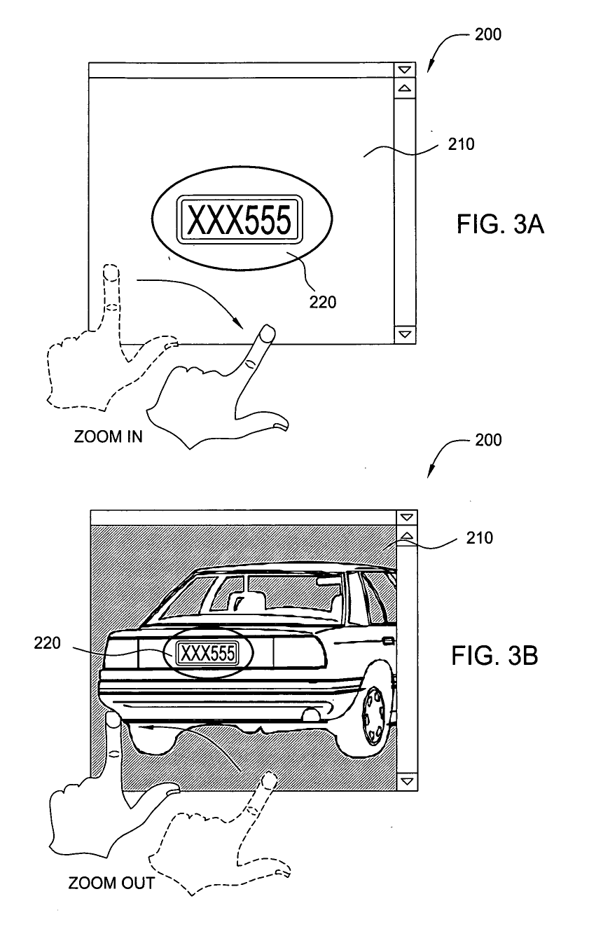

In some embodiments of the present invention, after an object has been selected on the touch screen, the user may zoom in on the selected object of interest while the scene is being recorded. As shown in FIG. 3A, a user may hold his finger on the selected object (i.e., license plate 220), or he may stroke the object on the touch screen (e.g., in a downward direction) in order to zoom in on the object. In response, the digital video recording device may zoom in and focus on the selected object while changing the backlight compensation settings based on the lighting conditions of the surrounding area in order to provide for a clear and recognizable image of the object while the scene is being recorded. The user also has the option of zooming out of the scene by stroking the object on the screen (e.g., using an upward direction) as shown in FIG. 3B. In response, the digital video recording device may zoom out and change the backlight compensation settings based on the lighting conditions of the surrounding area in order to provide a clear image of a larger screen area.

In another embodiment of the present invention, a user may utilize a handheld pointing device (e.g., a computer mouse) to select an object, zoom in on an object or zoom out of a scene containing the object.

In one embodiment of the present invention, a still image of the object may be taken (e.g., by double-clicking on the touch screen control panel 200) while the scene is being recorded.

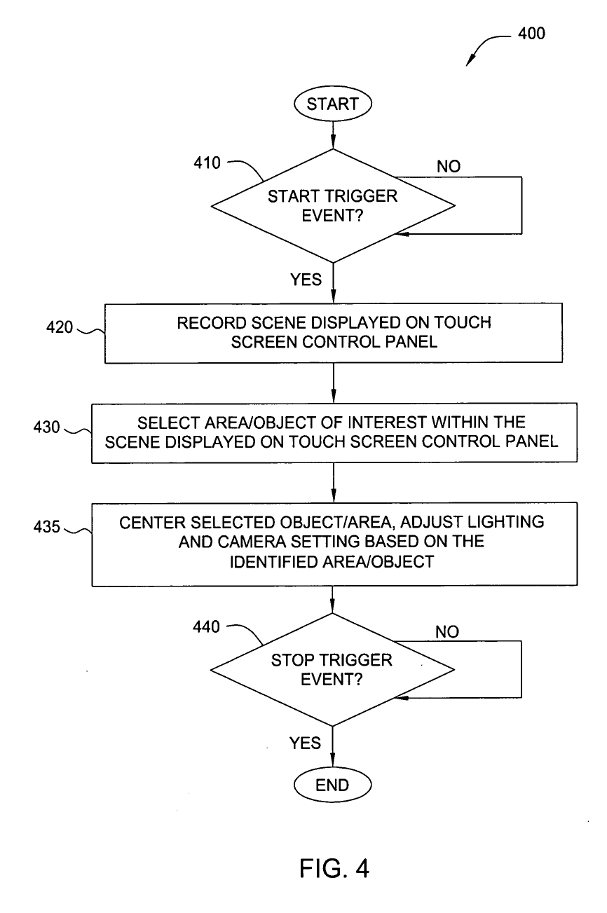

FIG. 4 illustrates operations 400 according to an implementation of the present invention. The operations 400 may be performed, for example, by a digital video recording device with a touch screen control panel. The operations may be best understood with simultaneous reference to FIGS. 2A, 2B, 3A and 3B.

The operations 400 begin at step 410, where the digital video recording device monitors for a start recording event. In one embodiment of the present invention, for example, a start recording event may be the manual pressing of a record button, or sending of a signal to the digital video recording device from a mechanism such as a wireless microphone. At step 420, in response to detecting a start recording event, the digital video recording device may start to record the scene displayed on the touch screen panel while monitoring for a stop triggering event.

At step 430, a user may select an object located in the scene (or screen area) by touching the object displayed on the touch screen control panel 200. At step 435, in response to a user's selection of a particular object or area shown on the touch screen control panel, for example, license plate 220, the digital video recording device, at step 435, may center the selected object on the touch screen, tilt the camera, and change the backlight compensation settings based on the lighting conditions of the surrounding area for a clear and recognizable image of the object. In one embodiment of the present invention, a user may select an object of interest by pressing on the image of the object on the screen, drawing a shape around the object on the screen with his finger or a stylus, or touching a few reference points on the touch screen.

In one embodiment of the present invention, the digital video recording device is capable of zooming in on the selected object, for example by double-clicking on the object displayed on the touch screen, or by a downward stroking motion of the finger or stylus over the displayed object. In one embodiment of the present invention, the digital video recording device is adapted to take a snapshot of the scene by pressing and holding on the touch screen control panel for a pre-determined amount of time, for example, 10 seconds, while the scene is being recorded.

For some embodiments of the present invention, the digital video recording device may be adapted to lock on to a moving object while the scene is being recorded. In other words, the digital video recording device may be configured to follow the movement of a selected object. A user may lock the digital video recording device onto a selected object by pressing and holding on the selection for a pre-defined time period.

This inventive feature may be utilized in a number of applications. For example, for video recordings that may be used for evidentiary purposes, such as recording of a potential driving while intoxicated (DWI) offense, an officer may press on the facial portion of a suspect appearing on the touch screen control panel, thereby locking the digital video recording device. In response, the digital video recording device may center the object on the screen, tilt the camera, and change the backlight compensation settings based on the lighting condition of the surrounding area of the suspect's face in order to capture a clear and recognizable image of his facial expression and movements while the scene is being recorded.

At step 440, after detecting a stop triggering event, the digital video recording device may stop recording the scene. In one embodiment of the present invention, for example, a stop triggering event may be the manual pressing of a stop button, or sending of a signal to the digital video recording device from a mechanism, such as a wireless microphone.

In one embodiment of the present invention, the digital video recording device may utilize an image processing application (e.g., with optical character recognition) in order to analyze the image and extract the characters from a license plate. Then, the digital video recording device may use that information and automatically access a database (e.g., maintained by a department of motor vehicles or other such administrative entity) to retrieve information about the driver corresponding to the license plate. In this way, by automatically performing backlight compensation for a license plate to generate a clear image, the digital video recording device may allow an officer to automatically retrieve useful information based on a license plate number that may have otherwise been unreadable. By enhancing the recognition of a license plate, the digital video recording device enables an image processing application to extract the characters from a license plate and then automatically retrieves information about the driver associated with the license plate.

### CONCLUSION

By using a digital video recording device with a touch screen control panel that is adapted to record digital video data with adjusted light compensation based on a selected object within a scene, the user of the digital video recording device can easily and quickly focus on a particular object of interest on the screen and maintain focus and vigilance on activities within his surroundings.

Although the embodiments disclosed above, which incorporate the teachings of the present invention, have been shown and described in detail herein, those skilled in the art can readily devise other varied embodiments which still incorporate the teachings and do not depart from the spirit of the invention.

1. A vehicle-mounted digital video recording device for capturing video data during an event comprising:
a storage medium;
a touch screen control panel; and
a processing device configured to record a scene, receive a user selection of an object within the scene and then automatically perform compensation in order to enhance recognition of the selected object within the scene.

2. The digital video recording device of claim 1, wherein the user selects the object using the touch screen control panel.

3. The digital video recording device of claim 2, wherein the user may select the object displayed on the touch screen control panel by touching the object or tracing the object with a stylus or a finger.

4. The digital video recording device of claim 1, wherein the digital video recording device is adapted to adjust backlight compensation settings to obtain an enhanced image of the selected object in response to the user selection of the object, wherein the selected object may appear more enhanced than other parts of the scene.

5. The digital video recording device of claim 1, wherein the digital video recording device is adapted to take a snapshot of the object based on a user action while recording the scene.

6. The digital video recording device of claim 1, wherein the digital video recording device is adapted to zoom in based on a user action while recording the scene.

7. The digital video recording device of claim 1, wherein the digital video recording device is adapted to adjust backlight compensation settings and lock on to the object, wherein the digital video recording device is adapted to follow and track the object while recording the movements of the object.

8. The digital video recording device of claim 1, wherein the digital video recording device is adapted to capture a still image of the object and transfer the image to an character recognition unit.

9. The digital video recording device of claim 1, wherein the processing device is further configured to extract data from an image of the object, retrieve information about the extracted data, and display the retrieved information on the touch screen control panel.

10. The digital video recording device of claim 9, wherein extracting the data comprises performing character recognition to extract a license plate number from a license plate and retrieving information comprises retrieving data from a remote database.

11. A method for recording video data with a vehicle-mounted digital video capturing device corresponding to an event comprising:
displaying a scene representing the video data on a touch screen control panel while recording the scene; and
performing compensation in response to a user selection of a particular object or area located within the scene in order to enhance recognition of the selected object in the scene.

12. The method of claim 11, wherein the user may select the object displayed on the touch screen control panel by touching the object or tracing the object with a stylus or a finger.

13. The method of claim 11, wherein the digital video recording device is adapted to take a snapshot based on a user action while recording the scene.

14. The method of claim 11, wherein the digital video recording device is adapted to adjust backlight compensation settings and lock on to the object, wherein the digital video recording device is adapted to follow and track the object while recording the movements of the object.

15. The method of claim 11, further comprising:
extracting data from an image of the object;
retrieving information about the extracted data; and
displaying the retrieved data on the touch screen control panel, wherein the extracting the data comprises performing character recognition to extract a license plate number from a license plate and retrieving information comprises retrieving data from a remote database.

16. A method for recording video data corresponding to an event, comprising:
displaying a scene representing the video data on a touch screen control panel;
locking on to an object or an area in response to a user selection, wherein the digital video recording device is adapted to follow and track the object while recording its movements; and
performing compensation in response to the user selection of the object in order to enhance recognition of the selected object in the scene, wherein the selected object may appear more enhanced than other parts of the scene.

17. The digital video recording device of claim 16, wherein the digital video recording device is adapted to zoom in and take a snap shot while recording the scene in response to the user selection of the object or the area.

18. The method of claim 16, wherein the digital video recording device is adapted to center the object or the area while the digital video recording device is recording the scene.

19. The method of claim 16, wherein the digital video recording device is adapted to adjust a camera angle in order to obtain an enhanced image of the selected object or the area in response to the user selection of the object.

20. The method of claim 16, wherein the user selects the object or the area using the touch screen control panel.
